(19) United States
(12) Patent Application Publication
(10) Pub. No.: US 2015/0268922 A1
(43) Pub. Date: Sep. 24, 2015

(54) Personalized News Program

(71) Applicant: Tribune Digital Ventures, LLC, Chicago, IL (US)

(72) Inventor: Gregory P. Defouw, Redwood City, CA (US)

(73) Assignee: Tribune Digital Ventures, LLC, Chicago, IL (US)

(21) Appl. No.: 14/220,970

(22) Filed: Mar. 20, 2014

(51) Int. Cl. G06F 3/16

(52) U.S. Cl. CPC G06F 3/165

(57) ABSTRACT

An example method involves determining an attribute of a user of a client device and selecting an audible version of a news story. The selection of the audible version of the news story is based on an association between the determined attribute and an attribute of the audible version of the news story. In the example method, the attribute of the audible version is indicative of an accent of the audible version of the news story. The method also includes generating a playlist for a personalized news program. The playlist includes a reference to the selected audible version of the news story. Further, the example method includes transmitting the generated playlist to the client device.

In this disclosure, unless otherwise specified and/or unless the particular context clearly dictates otherwise, each usage of “a” or “an” means at least one, and each usage of “the” means the at least one.

### TECHNICAL FIELD

This disclosure relates generally to computing devices, and more particularly, to computing devices configured for providing media content such as personalized news programs for instance.

### BACKGROUND

Unless otherwise indicated herein, the materials described in this section are not prior art to the claims in this disclosure and are not admitted to be prior art by inclusion in this section.

To listen to the radio, a listener typically tunes a receiver to a particular frequency (e.g., an AM or FM frequency) and listens to music, news, or other audible content being broadcast on that frequency by a radio station. The listener may tune the receiver, and therefore select a radio station, in a variety of ways, such as by rotating a dial, pushing a seek button, or pushing a station preset button. By selecting one of multiple radio stations, the listener may exert some control over the audible content presented to the listener. However, although the listener may control which station is selected, the listener is unlikely to have any influence over the audible content that is broadcast by the selected station.

Typically, a radio station broadcasts the same audible content to multiple receivers, and therefore to multiple listeners, at the same time. Given this, it is common for a radio station to produce and broadcast audible content that is intended to appeal to a variety of different listeners. However, while some listeners may find such audible content appealing, other listeners may find it unappealing because it is not tailored to their particular interests.

### SUMMARY

In one aspect, a method is disclosed. The method involves determining an attribute of a user of a client device and selecting an audible version of a news story. The selection of the audible version of the news story is based on an association between the determined attribute and an attribute of the audible version of the news story. In this aspect, the attribute of the audible version is indicative of an accent of the audible version of the news story. The method also includes generating a playlist for a personalized news program. The playlist includes a reference to the selected audible version of the news story. Further, the method includes transmitting the generated playlist to the client device.

In another aspect, a non-transitory computer-readable medium is disclosed. The medium has stored thereon program instructions that when executed by a processor cause performance of a set of functions. The set of functions include determining an attribute of a user of a client device and accessing data representing first and second audible versions of a news story. The data includes a first attribute of the first audible version and a second attribute of the second audible version. The first attribute is indicative of a first accent of an audible version of the news story and the second attribute is indicative of a second accent of the audible version of the news story, and the first accent is different than the second accent. The functions also include selecting an audible version of the news story from among the first and second audible versions. The selection of the selected audible version is based on an association between the determined attribute and either the first accent or the second accent. Further, the functions include generating a playlist for a personalized news program. The playlist includes a reference to the selected audible version of the news story. The functions also include transmitting the generated playlist to the client device.

In another aspect, a server device is disclosed. The server includes a communication interface, a processor, and a non-transitory computer-readable medium having stored thereon program instructions that when executed by the processor cause the server to perform a set of functions. The set of functions include determining an attribute of a user of a client device and accessing an attribute of an audible version of a news story. The attribute indicates an accent of the audible version of the news story. The functions also include using the determined attribute and the accessed attribute as a basis to generate a playlist of a news program that includes the audible version of the news story, and transmitting the generated playlist to a client device.

In another aspect, another method is disclosed. The method involves determining an attribute of a user of a client device and selecting an audible version of a news story. The selection of the audible version of the news story is based on an association between the determined attribute and an attribute of the audible version of the news story. In this aspect, the attribute of the audible version is indicative of an accent of the audible version of the news story. The method also includes generating a playlist for a personalized news program. The playlist includes a reference to the selected audible version of the news story. The method also includes traversing the generated playlist, and for each media content item referenced by the playlist, (i) retrieving data representing the media content item, and (ii) using the retrieved data to play out the media content item.

These, as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a simplified block diagram of an example system;

FIG. 2 is a flow chart depicting functions of an example method;

FIG. 3 is a diagram of an example playlist template;

FIG. 4 is a diagram of an example playlist;

FIG. 5 is a flow chart depicting functions of another example method;

FIG. 6 is a flow chart depicting functions of another example method.

### DETAILED DESCRIPTION

### I. Overview

As indicated above, a radio station may produce and broadcast audible content that is intended to appeal to a variety of different listeners. For example, in the context of producing and broadcasting a news program, a narrator (such as a news anchor affiliated with the radio station, or another person) may read aloud news stories from each of a variety of different predetermined categories, such as sports, politics, and entertainment, and the readings may be included as part of the news program.

Although some listeners may be interested in audible versions of news stories from all of the predetermined categories, other listeners may have different interests. For example, one listener may be interested in sports and entertainment, but not politics, while another listener may be interested in politics and entertainment, but not sports. In either case, the listener may be presented with audible content that does not align with the listener's interests. As a result, the listener may find the news program unappealing.

One way to help address this issue is by implementing a system that provides a listener with a personalized news program. In one aspect, such a system may include at least two computing devices, such as a server and a client, and a communication network through which the server and the client may communicate.

In this system, the server and the client may perform a variety of functions. For example, the server may determine a set of attributes associated with a user of the client and may use the determined set of attributes as a basis to generate a playlist of a personalized news program for the user. The generated playlist defines a sequence of media content items, each of which may include audible content such as an audible version of a news story. An audible version of a news story may be referred to herein as an “audible news story.” The generated playlist may also specify media content attribute data respectively for each media content item, including for instance a reference to data representing the media content item and metadata characterizing the media content item. Collectively, this sequence of media content items may thus define a personalized news program for playout to the user.

After or as the server generates this playlist, the server may transmit the playlist to the client, and the client may traverse the entries of the playlist, retrieve data representing each referenced media content item, and use the data to play out each referenced media content item in accordance with the sequence defined by the playlist. In practice, for instance, for each media content item of the sequence, (i) the client may transmit to the server, or to another server for that matter, a request for data representing the media content item, (ii) the server may receive the transmitted request, (iii) responsive to the server receiving the transmitted request, the server may transmit to the client, the requested data, (iv) the client may receive the transmitted data, and (v) the client may play out for the user the media content item represented by the received data.

Optimally, this process may involve streaming of the data representing the media content items to the client and playout of the sequence of media content items in real time by the client. In particular, for each media content item referenced by the playlist, the client may request a server to stream the data representing the media content item to the client, and the client may then receive in response a data stream defining the requested media content item. As the client receives and buffers the requested data representing the media content items in sequence, the client may then play out the represented media content items to a user, thus providing the user with a substantially continuous playout of the media content items defining the personalized news program.

As noted above, a media content item, and therefore an audible version of a news story may be represented by data. Data representing an audible version of a given news story may be generated in a variety of ways. For instance, the data may be generated by recording a human's verbal reading of a text-based version of the news story. Data generated in this manner may be referred to herein as “recorded voice data.” Alternatively, the data may be generated via a text-to-speech (TTS) system based on data representing the text-based version of the news story. Data generated in this manner may be referred to herein as “TTS data.” Upon a server receiving a request from a client for data representing an audible version of a news story, the server can fulfill the request by sending the available representative data (e.g., recorded voice data or TTS data) to the client.

To generate recorded voice data for a given news story, the server may transmit a request to a remote recording station. A narrator at the recording station can then read aloud a text-based version of the news story into a microphone so that the recorded voice data can be recorded and transmitted to the server. The server can then store the recorded voice data and can use the recorded voice data to fulfill a request for data representing an audible version of the news story.

To generate TTS data for a given news story, the server may receive and provide data representing a text-based version of the news story to a TTS system. The TTS system may then process the data and output the corresponding TTS data. In one example, the TTS system may incorporate a variety of software-implemented and/or hardware-implemented logic instructions in combination with synthesizers to facilitate such functions. The server may then store the TTS data and use the TTS data to fulfill a request for data representing an audible version of the news story.

In accordance with the present disclosure, one way to help render a news program, or for that matter, any sequence of media content items, more appealing to a user is for the server to determine an attribute associated with an audible version of a news story, namely an attribute that is indicative of an accent that characterizes the audible version of the news story, and for the server to use the determined attribute as a basis to generate a playlist for the news program. This attribute may be referred to herein as an “accent attribute.”

Generally, an accent is a way of pronouncing a language. An accent can be particular to an individual, location, region, nation, etc. As noted above, an audible version of a news story can be represented by recorded voice data or TTS data. In either case, the audible version of the news story may be associated with an accent attribute. In the case where the audible version of the news story is represented by recorded voice data, the accent attribute may characterize the accent of the narrator's voice. Alternatively, where the audible version of the news story is represented by TTS data, the accent attribute may characterize the accent of a simulated or electronic voice used by the TTS system. The present disclosure recognizes that TTS systems now known or future developed can provide such functionality.

In practice, there may be multiple audible versions of the same news story, where each audible version is characterized by a different accent. In some instances, a user may prefer listening to a first audible version of a news story that is characterized by a first accent rather than a second audible version of the news story that is characterized by a second accent. Among other factors, the user may find that the pronunciation, stress, tone, cadence, and/or speech patterns represented by the first accent is more pleasant, familiar, understandable, entertaining, etc. than those represented by the second accent, and therefore the first audible version of the news story may be preferentially provided by the server when the sever generates a playlist for that user.

Of course, in selecting an audible news story, the server may also consider other factors, such as another attribute associated with the audible news story and/or an attribute associated with the user (e.g., such that the news program may be personalized for the user). Accordingly, in one example, the server may use an accent attribute of an audible version of an audible news story as a factor among others in determining whether or not to select that audible version in connection with generating a playlist.

After or as the server generates this playlist, the server may transmit the playlist to the client such that the client may playout each referenced audible news story as described above. As a result, the user may be presented with a news program that may be appealing to the user.

### II. Example System

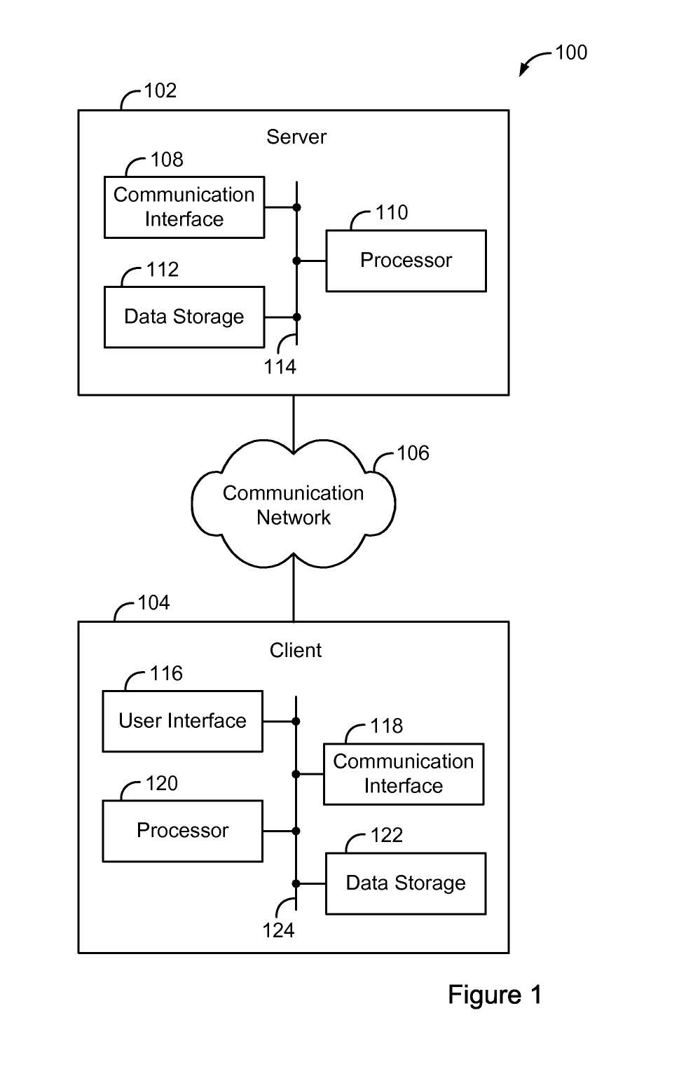

FIG. 1 is a simplified block diagram of an example system 100 in which aspects of the present disclosure can be implemented. As shown, the system 100 includes at least two computing devices, namely a server 102 and a client 104, and a communication network 106. Generally, the server 102 and the client 104 are configured for communicating with each other via the communication network 106.

A. Server

The server 102 may be configured for performing a variety of functions, such as those described in this disclosure (including the accompanying drawings). For example, the server 102 may be configured for establishing and transmitting to the client 104 a playlist defining a sequence of media content items that may define a personalized news program for instance, and for streaming data representing various media content items to the client 104 via the communication network 106, such that the client 104 may playout the represented media content items.

The server 102 may take a variety of forms and may include various components, including for example, a communication interface 108, a processor 110, and a data storage 112, all of which may be communicatively linked to each other via a system bus, network, or other connection mechanism 114.

The communication interface 108 may take a variety of forms and may be configured to allow the server 102 to communicate with one or more devices according to any number of protocols. For instance, the communication interface 108 may be configured to allow the server 102 to communicate with the client 104 via the communication network 106. In one example, the communication interface 108 may take the form of a wired interface, such as an Ethernet interface. As another example, the communication interface 108 may take the form of a wireless interface, such as a cellular or WI-FI interface.

The processor 110 may include a general purpose processor (e.g., a microprocessor) and/or a special purpose processor (e.g., a digital signal processors (DSP)).

The data storage 112 may include one or more volatile, non-volatile, removable, and/or non-removable storage components, such as magnetic, optical, or flash storage, and may be integrated in whole or in part with the processor 110. Further, the data storage 112 may take the form of a non-transitory computer-readable storage medium, having stored thereon program instructions (e.g., compiled or non-compiled program logic and/or machine code) that, when executed by the processor 110, cause the server 102 to perform one or more functions, such as those described in this disclosure.

B. Client

Likewise, the client 104 may be configured for performing a variety of functions such as those described in this disclosure. For example, the client 104 may be configured for receiving from the server 102 a playlist defining a sequence of media content items to be played out by the client, traversing the entries of the playlist, retrieving the data representing each referenced media content item, and using the retrieved data to play out each referenced media content item in accordance with the sequence defined by the playlist

The client 104 may take a variety of forms, including for example, a mobile phone, tablet, laptop, media player, gaming device, wearable device, or vehicle. And the client 104 may include various components, including for example, a user interface 116, a communication interface 118, a processor 120, and a data storage 122, all of which may be communicatively linked with each other via a system bus, network, or other connection mechanism 124.

The user interface 116 may be configured for facilitating interaction between the client 104 and a user of the client 104, such as by receiving input from the user and providing output to the user. Thus, the user interface 116 may include input components such as a computer mouse, a keyboard, a touch-sensitive panel, or perhaps a microphone for receiving voice commands. In addition, the user interface 116 may include output components such as a display screen (which, for example, may be combined with a touch-sensitive panel) a sound speaker or other audio output mechanism, and a haptic feedback system. Furthermore, the user interface 116 may include a digital-analog conversion unit to facilitate playout of media content to a user. Moreover, the client 102 may provide output to the user via another user interface system (e.g., the client 102 may communicate with an audio output system via a short range wireless communication, such as a connection established in accordance with IEEE 802.15).

The communication interface 118 may take a variety of forms and may be configured to allow the client 104 to communicate with one or more devices according to any number of protocols. For instance, the communication interface 118 may be configured to allow the client 104 to communicate with the server 102 via the communication network 106. Further, the communication interface 118 may take the form of a wired or wireless interface.

The processor 120 may include a general purpose processor and/or a special purpose processor. The data storage 122 may include one or more volatile, non-volatile, removable, and/or non-removable storage components, and may be integrated in whole or in part with the processor 120. Further, the data storage 122 may take the form of a non-transitory computer-readable storage medium, having stored thereon program instructions that, when executed by the processor 120, cause the client 104 to perform one or more functions, such as those described in this disclosure. Such program instructions may define or be part of a discrete software application, such a native app or web app, that can be executed upon user request for instance.

C. Communication Network

Generally, the communication network 106 may be configured to allow the server 102 and the client 104 to communicate with each other using any number of protocols. In addition, the communication network 106 may take a variety of forms, including for example a packet-switched network such as the Internet.

### III. Example Operations

Methods of this disclosure will now be described principally in connection with providing a personalized news program to a user of the client 104. It will be understood, however, that this disclosure can extend to apply with respect to providing other types of media content as well, not necessarily limited to personalized news programs.

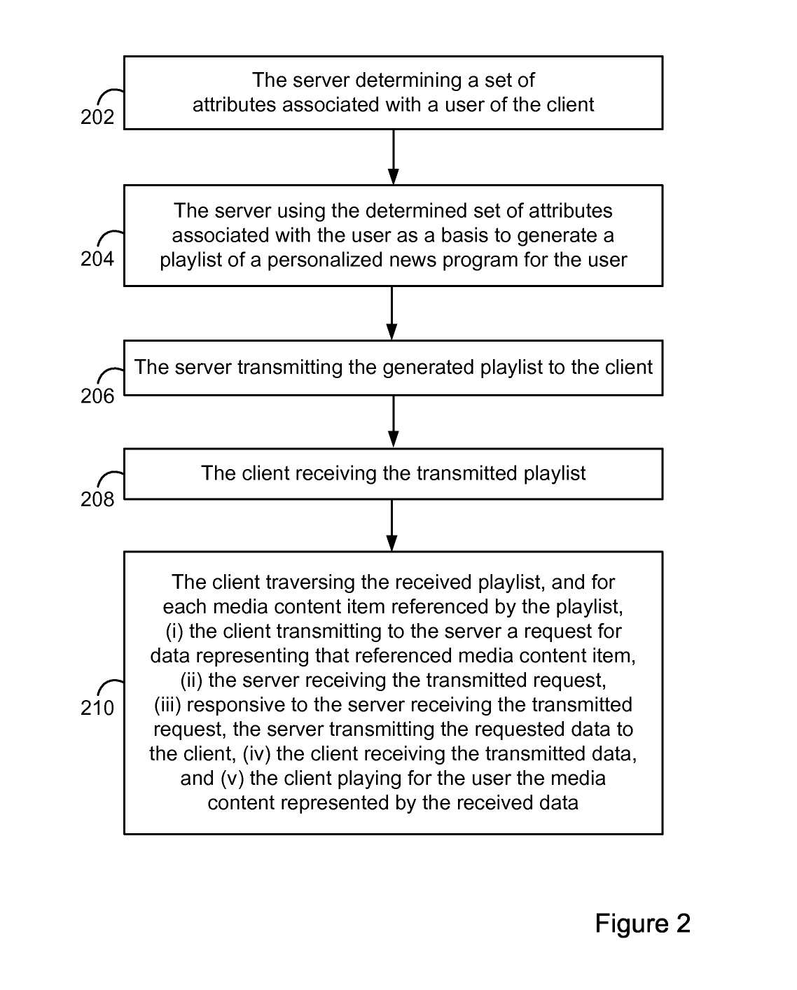

FIG. 2 is a flow chart depicting functions that can be carried out in an example method for providing a user of the client 104 with a personalized news program. At block 202, the example method involves the server 102 determining a set of (i.e., one or more) attributes associated with a user of the client 104. At block 204, the method then involves the server 102 using the determined set of attributes as a basis to generate a playlist of a personalized news program for the user. At block 206, the method then involves the server 102 transmitting the generated playlist to the client 104, and at block 208, the method involves the client 104 receiving the transmitted playlist. At block 210, the method then involves the client 104 traversing the received playlist, and for each media content item referenced by the playlist, (i) the client transmitting to the server a request for data representing that referenced media content item, (ii) the server receiving the transmitted request, (iii) responsive to the server receiving the transmitted request, the server transmitting the requested data to the client, (iv) the client receiving the transmitted data, and (v) the client playing for the user the media content item represented by the received data.

In this process, each user-associated attribute that the server 102 determines may take various forms. By way of example, each attribute may relate to one or more of the following: the user's extent of interest in a particular type of news story, the user's interest in a particular type of audible news story, whether the user has a subscription to a news-related product or service (e.g., a newspaper subscription), the user's age, the user's gender, the user's current location, the user's destined location (e.g., a location to which the user is driving), the weather at the user's current location, the weather at the user's destined location, and the user's estimated travel time between the user's current location and the user's destined location.

Further, the function of the server 102 determining the set of attributes associated with the user may take various forms. In one example implementation, for instance, the server 102 may receive from the client 104 an identification of the user of the client 104, and the server 102 may then refer to one or more data sources that correlate or facilitate correlation of that identification with an attribute, so as to determine an attribute associated with the user. And in another example implementation, the client 104 itself may determine a user-associated attribute and may report the determined attribute to the server 102, in which case the server would determine the user-associated attribute by receiving the reported attribute from the client 104. To facilitate this, the client 104 may provide a configuration interface through which the user can manually enter or select a user-associated attribute, and the client 104 may thus determine the user-associated attribute by receiving user indications of the user-associated attribute through that interface. Alternatively or additionally, the client 104 may determine a user-associated attribute by evaluating information associated with the user, such as user profile records, browsing history, shopping history, location history, and the like. Other examples are possible as well.

For this purpose, the client 104 may determine the attribute associated with the user in a variety of ways. As one example, the client 104 may receive the attribute as input from the user. As another example, the client 104 may receive other input from the user, and the client 104 may use the input as a basis to determine the attribute. For instance, the client 104 may receive input from the user, such as the user's destined location, and the client 104 may use a positioning device and a navigation software application to determine the user's estimated travel time from the user's current location to the user's destined location. In some instances, the client may communicate with the server 102 or another server, such as a server affiliated with the mapping application, to determine such an attribute. Other example techniques for determining an attribute associated with a user are possible as well.

The server 102 may then use the determined set of attributes associated with the user in various ways to generate the playlist of the personalized news program for the user. For instance, based on the set of user-associated attributes, the server 102 may select particular audible news stories or types of audible news stories to specify as media content items in the playlist. As such, the server 102 may be configured with data that maps particular sets of user-associated attributes with particular types of audible news stories, possibly giving more weight to inclusion of certain types of audible news stories than to other types of audible news stories. For example, the data may indicate that a particular set of user-associated attributes suggests more likely user interest in entertainment news than in politics news, in which case the server 102 may structure the playlist to specify a greater extent of entertainment-related audible news stories than politics-related audible news stories. As another example, the data may indicate that a particular set of user-associated attributes suggests great user interest in sports, in which case the server 102 may structure the playlist to specify a relatively great extent of sports-related audible news stories.

In some examples, an audible news story's type may be defined by a set of attributes associated with the audible news story, examples of which may include or relate to one or more of the following: the audible news story's category, the audible news story's target demographic (e.g., by age, gender, or location), the audible news story's creation date, the audible news story's author or other attribution information, the extent of popularity of the audible news story, the extent of popularity of a person or topic related to the audible news story, or the manner in which data representing the audible news story was generated.

These attributes may be stored in a variety of ways. For example, they may be stored as metadata along with the data representing the audible news story to which they correspond. These attributes may also be set in a variety of different ways, such as by a user via a user interface.

As indicated above, a media content item such as an audible news story may be represented by data. This data may be generated in a variety of ways. For example, the server 102 may generate data representing an audible news story by recording a narrator reading aloud a text-based version of the news story, or by using a well-known TTS software and/or hardware system to convert data representing a text-based version of a news story into data representing an audible version of the news story. Further, data representing a media content item may be stored in a variety of ways. For example, the data may be stored in the form of a digital audio file in a data storage, such as the data storage 112.

In one implementation, the function of the server 102 using the determined set of attributes associated with the user as a basis to generate a playlist of a personalized news program for the user may involve the server 102 (i) using the determined set of attributes associated with the user as a basis to select a playlist template from a group of templates (e.g., stored in the data storage 112), (ii) using the selected playlist template as a basis to select a set of audible news stories from a group of audible news stories (e.g., stored in the data storage 112), and (iii) generating a playlist that includes references to each audible news story from the selected set of audible news stories.

Generally, a playlist template serves as an outline for a playlist and may define a sequence of placeholders for media content attribute data and/or media content attribute data itself. For each placeholder, the playlist template may further specify placeholder attribute data. Based on this placeholder attribute data, the server 102 may select a set of audible news stories, and replace that placeholder with media content attribute data for the selected set of audible news stories, thereby converting the playlist template into a playlist.

There may be a variety of different types of placeholder attribute data, examples of which may include a quantity tag and a type tag. A quantity tag specifies a quantity of audible news stories that the server 102 should select for the corresponding placeholder. And the type tag specifies the particular types of audible news stories that the server 102 should select for the corresponding placeholder.

As indicated above, a playlist template may define a sequence of placeholders for media content attribute data and/or media content attribute data itself. In the case where the sequence defines media content attribute data, the server 102 may “carry though” the media content attribute data from the playlist template to the playlist as the server 102 generates the playlist.

In line with the discussion above, the playlist that the server 102 generates may define an ordered sequence of entries, each of which provides media content attribute data regarding a respective media content item, such as a particular audible news story. In practice, the playlist may provide this information in various ways, such as with use of extensible markup language (XML) for instance, in a manner that the client 104 would be configured to read.

For a given media content item, the media content attribute data may include a reference to the data representing the media content item, such as a network address or content identifier that the client 104 can read and use as a basis to request and receive the data representing the media content item for playout of the represented media content item. Thus, the client 104 may read the reference indicated for a given media content item to determine a network address or the like from which to obtain the data representing the media content item, and the client 104 may request and receive the data representing the media content item from that network address or by otherwise using the indicated reference.

Such a reference may have various levels of granularity. By way of example, the reference may be specific to data representing a particular audible news story, by specifying a particular story identifier or name of a news story media file for instance, in which case the client 104 could request the server 102 to transmit that data representing that particular audible news story and the server 102 could retrieve that data representing that particular audible news story from data storage and transmit it to the client 104. And as another example, the reference may be more general, specifying a class of news story, such as “traffic” or “weather” for instance, in which case the client 104 could request the server 102 to transmit data representing an audible news story of that class generally, and the server 102 may then retrieve data representing a latest or most pertinent audible news story of that class and transmit it to the client 104. Further, any or all of these references may refer to locations other than server 102, such as to one or more other servers for instance.

Further, the server 102 may transmit the generated playlist to the client 104, and the client 104 may receive the generated playlist, in various ways. By way of example, the client 104 may transmit to the server 102 a hypertext transfer protocol (HTTP) request or the like seeking the playlist, and the server 102 may respond by generating the playlist and transmitting the playlist to the client 104 in an HTTP response or the like.

Continuing with reference to FIG. 2, as noted above, at block 210, the method involves the client 104 traversing the received playlist, and for each media content item of the sequence, (i) the client transmitting to the server, a request for data representing the media content item, (ii) the server receiving the transmitted request, (iii) responsive to the server receiving the transmitted request, the server transmitting to the client, the requested data, (iv) the client receiving the transmitted data, and (v) the client playing out for the user the media content item represented by the received data.

As further noted above, this process may involve streaming of the data representing the media content item from the server 102, or from one or more other servers, to the client 104. In practice, for instance, as the client 104 traverses the playlist, the client 104 may read each successive entry to determine the reference that the entry specifies for a media content item, and the client may transmit to the server 102 a request for the server 102 to stream the data representing that media content item to the client 104. To facilitate this, the client 104 may engage in signaling with the server 102 in accordance with the Real Time Streaming Protocol (RTSP), to establish a streaming media session and to specify the data representing the media content to be streamed, and the server 102 may stream the requested data to the client 104 in accordance with the Real-time Transport Protocol (RTP). As the client 104 receives this streamed data, the client 104 may then buffer and play out the content represented by the data in real time, providing the user with substantially continuous playout of the news program.

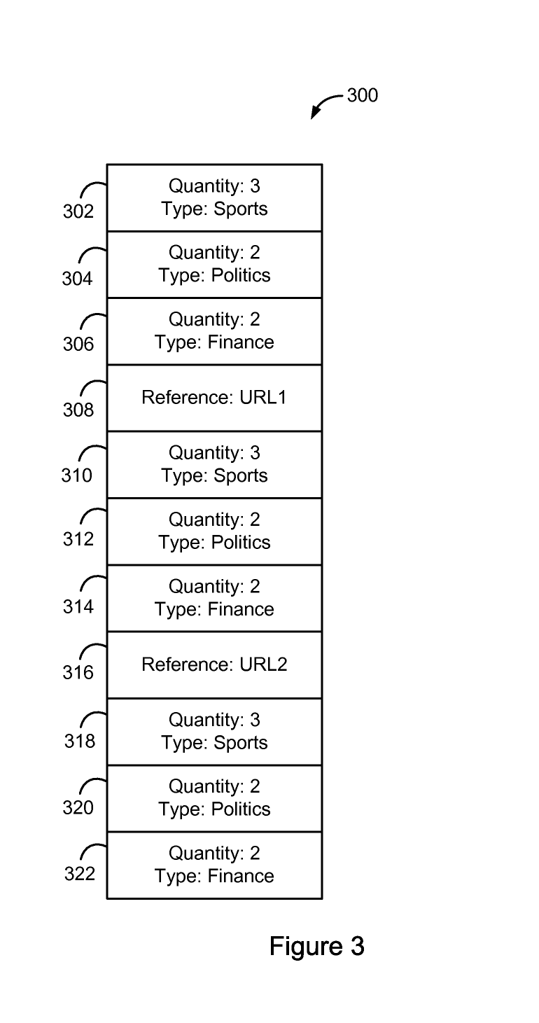

To help appreciate operation of this process, FIG. 3 shows an example playlist template 300. The template 300 includes eleven ordered entries 302-322 (even numbers only). Each of the entries 302, 304, 306, 310, 312, 314, 318, 320, and 322 serves as a placeholder for media content attribute data. And each of those entries includes placeholder attribute data, namely a quantity tag and a type tag. For example, the entry 302 includes a quantity tag that specifies “3” and a type tag that specifies a “Sports” category type. As another example, the entry 304 includes a quantity tag that specifies “2” and a type tag that specifies a “Politics” category type. Further, each of the entries 308 and 316 include media content attribute data. In particular, the entry 308 includes the reference “URL1” and the entry 316 includes the reference “URL2.”

As indicated above, at block 204, the method may involve the server 102 using the selected playlist template as a basis to select a set of audible news stories from a group of audible news stories (e.g., stored in the data storage 112). This may involve, for each entry that serves as a placeholder of media content attribute data, the server 102 using the quantity and type tags of that entry as a basis to select a set of audible news stories. For example, for the entry 302, the server 102 may select a set of 3 audible news stories that are all associated with a sports category attribute. As another example, for the entry 304, the server 102 may select a set of two audible news stories that are all associated with a politics category attribute.

Additionally or alternatively, the server 102 may determine an attribute associated with an audible news story, and the server 102 may use the determined attribute as a basis to select the set of audible news stories from the group of audible news stories.

As noted above, block 204 may involve generating a playlist that includes references to each audible news story from the selected set of audible news stories. This may involve the server 102 replacing placeholders of the playlist template with the appropriate selected sets of audible news stories, and thereby generating a playlist by “converting” the playlist template into a playlist.

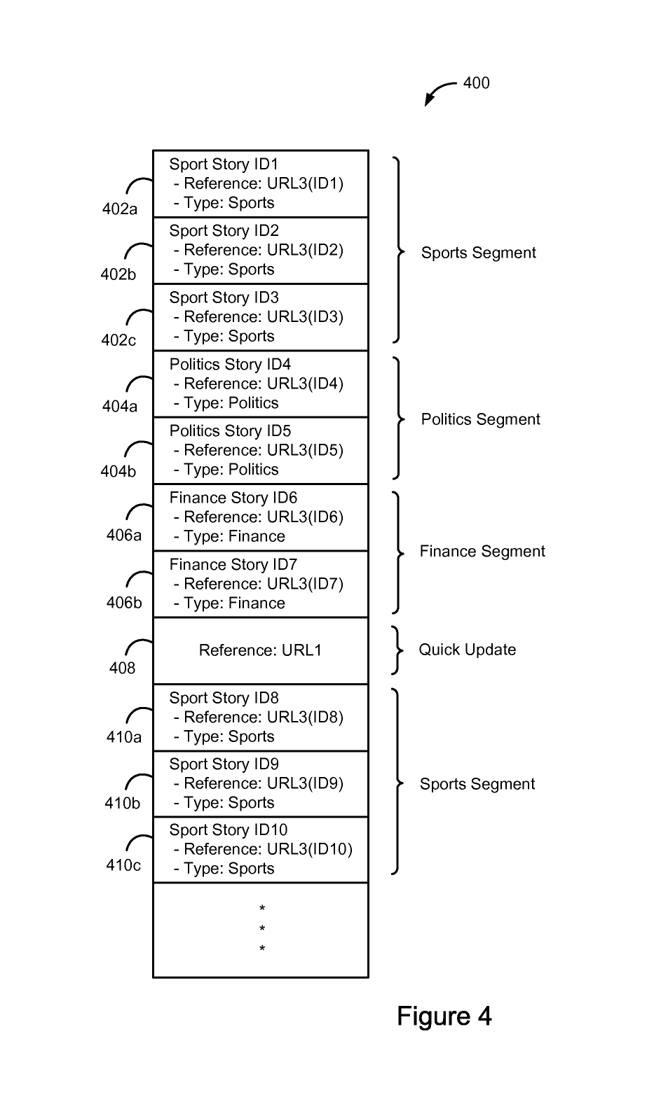

FIG. 4 shows a portion of an example playlist 400 that the server 102 may generate after the server 102 selects the playlist template 300. As shown, the generated playlist 400 include entries 402a-c, 404a-b, 406a-b, and 410a-c, each of which is for a respective audible news story and designates a respective reference and category type. For example, entry 402a designates a “Sports Story ID1,” with a reference in the form of “URL3” that may point to the server 102 and that designates “ID1” as a query parameter or the like, and with a category type indication of “Sports.” Entry 402b then designates a “Sports Story ID2,” with a reference in the form of “URL3” that may point to the server 102 and that designates “ID2” as a query parameter, and with a category type indication of “Sports.” And entry 402c designates a “Sports Story ID3,” with a reference in the form of “URL3” that may point to the server 102 and that designates “ID3” as a query parameter, and with a category type indication of “Sports.” As shown, this portion of the playlist 400 may be referred to as the “Sports Segment.”

As another example, entry 404a designates a “Politics Story ID4,” with a reference in the form of “URL3” that may point to the server 102 and that designates “ID4” as a query parameter, and with a category type indication of “Politics.” And entry 404b designates a “Politics Story ID5,” with a reference in the form of “URL3” that may point to the server 102 and that designates “ID5” as a query parameter, and with a category type indication of “Politics.” As shown, this portion of the playlist 400 may be referred to as the “Politics Segment.”

Since the entry 308 of the playlist template 300 included media content attribute data, namely the reference URL1, the server 102 may “carry though” the media content attribute data from the playlist template 300 to the playlist 400 as the server 102 generates the playlist 400. Accordingly, the entry 408 indicates the reference “URL3.” As shown, this portion of the personalized news program may be referred to as a “quick update.” In one example, a quick update may provide relatively small portions of data-centric information (e.g., traffic or weather information) to break up two segments in the personalized news program.

For brevity, FIG. 4 does not show additional entries after 410c, but it should be apparent that the server 102 may generate the remainder of the playlist 400 using the techniques described above.

As noted above, the server 102 may determine an attribute associated with an audible news story, and the server 102 may use the determined attribute as a basis to select the set of audible news stories from the group of audible news stories. An example of such an attribute is an accent attribute, which as noted above, is an attribute that is indicative of an accent that characterizes an audible version of a news story.

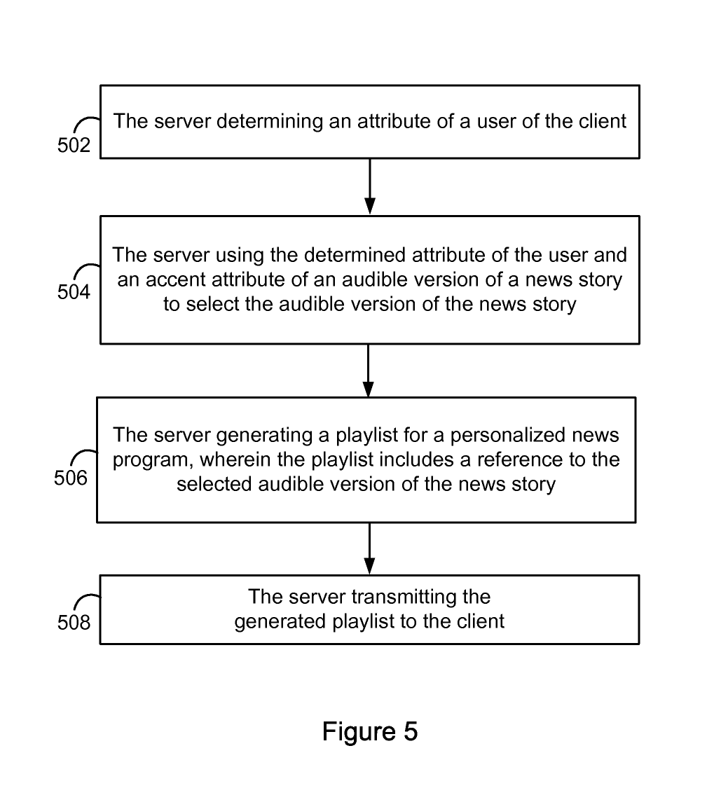

FIG. 5 is a flow chart depicting functions that can be carried out in another example method for providing a user of the client 104 with a personalized news program. At block 502, the example method involves the server 102 determining an attribute of a user of the client 104. This may involve the server performing one or more of the functions described above in connection with the function of block 202. In one example, the determined attribute is a location of the user, although other examples can include the user's birthplace or places of upbringing, the user's destined location, the user's education, etc. Since a user of the client 104 is likely to be proximate the client 104 when using it, in connection with this example method, any reference to a location of the user refers to a location of the user and/or a location of the client 104.

At block 504, the method involves the server 102 using the determined attribute and an accent attribute of an audible version of a news story to select the audible version of the news story from among multiple audible versions of the same text-based version of the news story. The multiple audible versions of the news story can be characterized by different accents and accent attributes. An accent attribute is indicative of an accent of the audible version of the news story, and can be stored as metadata along with the data representing the audible version. In the present example, at block 504, and the server 102 can access the accent attributes of the multiple audible versions and select the audible version with an accent attribute having the closest or best association with the user attribute.

Illustratively, the location of the user can be associated with a particular accent, e.g., a “regional” accent or a “national” accent. In the context of a personalized news program being provided in the United States, one non-limiting example of a “national” accent is the General American or Standard American English accent that is widely used as the accent for news stories or broadcasts that are generally national in coverage. A national accent can be contrasted with “regional” accents that can be characteristic of certain geographic regions and may be used as the default accent for news stories that are considered to be, at least initially, generally regional in coverage. Non-limiting examples of regional accents include Southern American English accents, Northeastern accents, and other regional accents. However, it should be noted that as a general matter accents can and do change over time, such that what might now considered to be a “national” accent may later be replaced by another different “national” accent, may become a “regional” accent, or may disappear entirely.

In one example, a first user of a first client device in one of the Southern states may be associated with one or more of the Southern American English accents, a second user of a second client device in one of the various Northeastern states may be associated with one or more of the Northeastern accents, and a third user of a third client device in one of the various Midwest states may be associated with the General American accent. These example associations between users of client devices and various accents can be established by associating a location of a user or client device with the most prevalent accent used in and around the location.

In other examples, the association between a user of a client device and a preferred accent for an audible news story can be established by analyzing one or more user attributes, such as the user's place of birth or upbringing, a location where the user was educated, a user's destined location, etc. In yet other examples, a content provider can establish an association between some or all users and a preferred accent for an audible news story or other content item, such that the content provider's preferred accent can overrule a user's preferred accent. This might be the case if a particular accent is desired for branding purposes or to make an audible news story sound more authentic, for example.

In the example of FIG. 5, at block 504, the server 102 can select different audible versions of the same text-based version of the news story for different users, and each of the selected audible versions of the news story can be characterized by a different accent associated with an attribute of the user.

Further, in FIG. 5 at block 506, the method then involves the server 102 generating a playlist for a personalized news program, wherein the playlist includes a reference to the selected audible version of the news story. This may involve the server performing one or more of the functions described above in connection with the function at block 204 such that the generated playlist includes a reference to data representing the audible version of the news story.

And at block 508, the method involves the server 102 transmitting the generated playlist to the client. This may involve the server 102 performing one or more of the functions described above in connection with the function at block 206 such that the client 104 may receive and play out the media content items referenced by the generated playlist.

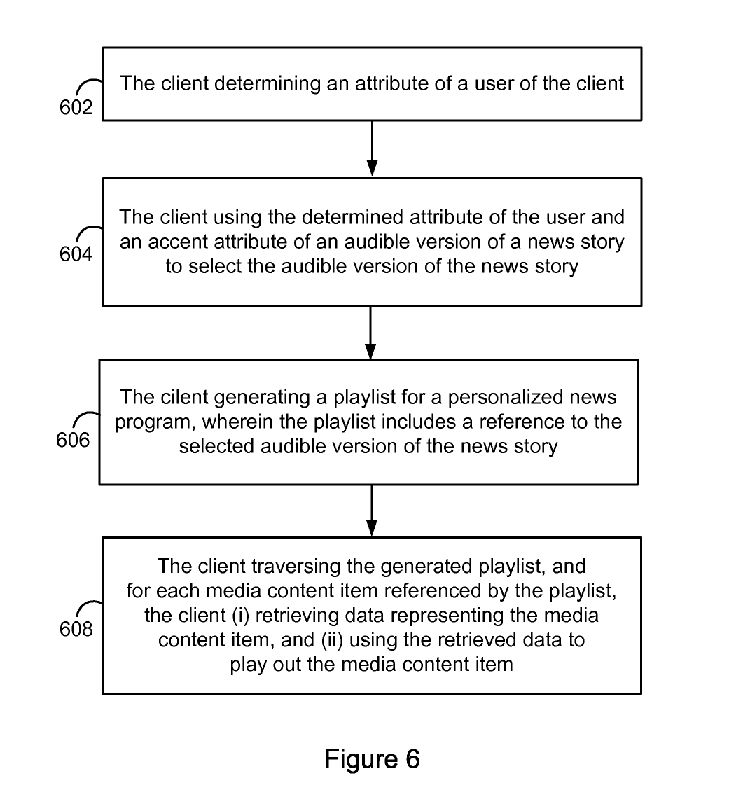

In some instances, another entity such as the client 104 may perform one or more of the functions described above as being performed by the server 102. An example of this is provided in connection with FIG. 6, which is a flow chart depicting functions that can be carried out in another example method for providing a user of the client 104 with a personalized news program.

At block 602, the example method involves the client 104 determining an attribute of a user of the client 104. At block 604, the method involves the client 104 selecting an audible version of a news story, wherein the selection of the audible version of the news story is based on an association between the determined attribute and an attribute of the audible version of the news story, wherein the attribute of the audible version is indicative of an accent of the audible version of the news story. At block 606, the method involves the client 104 generating a playlist for a personalized news program, wherein the playlist includes a reference to the selected audible version of the news story. At block 608, the example method involves the client 104 traversing the generated playlist, and for each media content item referenced by the playlist, the client 104 (i) retrieving data representing the media content item, and (ii) using the retrieved data to play out the media content item. In one example, the function at block 608 may involve additional functions performed by the server 102 and/or the client 104 such as those described above in connection with block 210.

### IV. Example Variations

The variations described in connection with select examples of the disclosed system and method may be applied to all other examples of the disclosed system and method.

Further, while one or more functions have been described as being performed by or otherwise related to certain devices or entities (e.g., the server 102 or the client 104), the functions may be performed by or otherwise related to any device or entity. As such, any function that has been described as being performed by the server 102 could alternatively be performed by a different server or by the client 104. For instance, in one example, a one server could generate and transmit a playlist to a client, and based on the playlist data of the playlist, the client could request and receive different portions of audible content from multiple other servers.

Further, the functions need not be performed in the disclosed order, although in some examples, an order may be preferred. Also, not all functions need to be performed to achieve the desired advantages of the disclosed system and method, and therefore not all functions are required.

While select examples of the disclosed system and method have been described, alterations and permutations of these examples will be apparent to those of ordinary skill in the art. Other changes, substitutions, and alterations are also possible without departing from the disclosed system and method in its broader aspects as set forth in the following claims.

1. A method comprising:
determining an attribute of a user of a client device;
selecting an audible version of a news story, wherein the selection of the audible version of the news story is based on an association between the determined attribute and an attribute of the audible version of the news story, wherein the attribute of the audible version is indicative of an accent of the audible version of the news story;
generating a playlist for a personalized news program, wherein the playlist includes a reference to the selected audible version of the news story; and
transmitting the generated playlist to the client device.

2. The method of claim 1, wherein the attribute of the user of the client device includes a location of the client device, wherein the location of the client device is associated with at least one of a first accent or a second accent, wherein the first accent is different than the second accent, and wherein the selected audible version is characterized by the associated first accent or the second accent.

3. The method of claim 1, wherein selecting the audible version of the news story includes selecting the audible version of the news story from among a plurality of audible versions of the news story, wherein the plurality of audible versions are characterized by different accents.

4. The method of claim 3, wherein the plurality of audible versions are readings of substantially the same text-based version of the news story.

5. The method of claim 3, wherein data representing at least one of the plurality of audible versions was generated by recording a human's verbal reading of a text-based version of the news story.

6. The method of claim 3, wherein data representing at least one of the plurality of audible versions was generated via a text-to-speech system based on data representing a text-based version of the news story.

7. The method of claim 1, wherein the attribute of the user is associated with a regional accent or a national accent, and wherein the selected audible version is characterized by the associated regional accent or the national accent.

8. The method of claim 1, wherein determining the attribute of the user comprises (i) determining user input data, and (ii) using the determined user input as a basis to determine the attribute associated with the user.

9. A non-transitory computer-readable medium having stored thereon program instructions that when executed by a processor cause performance of a set of functions, the set of functions comprising:
determining an attribute of a user of a client device;
accessing data representing first and second audible versions of a news story, wherein the data includes a first attribute of the first audible version and further includes a second attribute of the second audible version, wherein the first attribute is indicative of a first accent of an audible version of the news story, and the second attribute is indicative of a second accent of the audible version of the news story, and wherein the first accent is different than the second accent;
selecting an audible version of the news story from among the first and second audible versions, and wherein the selection of the selected audible version is based on an association between the determined attribute and either the first accent or the second accent;
generating a playlist for a personalized news program, wherein the playlist includes a reference to the selected audible version of the news story; and
transmitting the generated playlist to the client device.

10. The non-transitory computer-readable medium of claim 9, wherein the attribute of the user of the client device includes a location of the client device, wherein the location of the client device is associated with at least one of the first accent or the second accent, and wherein the selected audible version is characterized by the associated first accent or second accent.

11. The non-transitory computer-readable medium of claim 9, wherein the first and second audible versions are readings of substantially the same text-based version of the news story.

12. The non-transitory computer-readable medium of claim 9, wherein data representing at least one of the first and second audible versions was generated by recording a human's verbal reading of a text-based version of the news story.

13. The non-transitory computer-readable medium of claim 9, wherein the attribute of the user is associated with a regional accent or a national accent, and wherein the selected audible version is characterized by the associated regional accent or the national accent.

14. A server device comprising:
a communication interface;
a processor; and
a non-transitory computer-readable medium having stored thereon program instructions that when executed by the processor cause the server to perform a set of functions, the set of functions comprising:
determining an attribute of a user of a client device;
accessing an attribute of an audible version of a news story, wherein the attribute indicates an accent of the audible version of the news story;
using the determined attribute and the accessed attribute as a basis to generate a playlist of a news program that includes the audible version of the news story; and
transmitting the generated playlist to a client device.

15. The server device of claim 14, wherein the attribute of the user of the client device includes a location of the client device, wherein the location of the client device is associated with at least one of a first accent or a second accent, wherein the first accent is different than the second accent, and wherein the audible version of the news story included in the playlist is characterized by the associated first accent or second accent.

16. The server device of claim 14, further comprising accessing a second attribute or a second audible version of the news story, wherein the second attributes indicates a second accent of the second audible version of the news story, and wherein the first accent is different than the second accent, and further comprising selecting for inclusion in the playlist, based on an association between the determined attribute and the accessed attribute, the first audible version instead of the second audible version.

17. The server device of claim 16, wherein the first and second audible versions are readings of substantially the same text-based version of the news story.

18. The server device of claim 16, wherein data representing at least one of the first and second audible versions was generated by recording a human's verbal reading of a text-based version of the news story.

19. The server device of claim 16, wherein data representing at least one of the first and second audible versions was generated via a text-to-speech system based on data representing a text-based version of the news story.

20. The server device of claim 14, wherein the attribute of the user is associated with a regional accent or a national accent, and wherein the audible version of the news story included in the playlist is characterized by the associated regional accent or national accent.

21. A method comprising:
determining an attribute of a user of a client device;
selecting an audible version of a news story, wherein the selection of the audible version of the news story is based on an association between the determined attribute and an attribute of the audible version of the news story, wherein the attribute of the audible version is indicative of an accent of the audible version of the news story;
generating a playlist for a personalized news program, wherein the playlist includes a reference to the selected audible version of the news story; and
traversing the generated playlist, and for each media content item referenced by the playlist, (i) retrieving data representing the media content item, and (ii) using the retrieved data to play out the media content item.
